(19) United States
(12) Patent Application Publication
(10) Pub. No.: US 2005/0094660 A1
(43) Pub. Date: May 5, 2005

(54) Optical network unit and method for servicing ethernet-based digital broadcasting

(76) Inventors: Sang Woo Lee, Daejeon-city (KR); Kang Bok Lee, Daejeon-city (KR); Heyung Sub Lee, Daejeon-city (KR); Hyeong Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/862,103

(22) Filed: Jun. 3, 2004

(30) Foreign Application Priority Data
Oct. 29, 2003 (KR) 2003-75802

(51) Int. Cl. H04L 12/43

(52) U.S. Cl. 370/437; 370/395.53

(57) ABSTRACT

Provided are an optical network unit (ONU) and method for servicing Ethernet-based digital cable broadcasting. The ONU includes a received frame classifier, which receives an Ethernet frame from an OLT and classifies the Ethernet frame into a digital broadcasting frame or a nonbroadcasting frame; a broadcasting frame classifier, which sorts the digital broadcasting frame according to a channel; and a broadcasting frame processing unit, which examines a channel requested by a subscriber and transmits a broadcasting frame corresponding to the channel to the subscriber.

This application claims the priority of Korean Patent Application No. 2003-75802, filed on Oct. 29, 2003, in the Korean Intellectual Property Office, the disclosure of which is incorporated herein by reference in its entirety.

### BACKGROUND OF THE INVENTION

1. Field of the Invention

The present invention relates to an optical network unit (ONU) and method for servicing Ethernet-based digital broadcasting. More particularly, the present invention relates to an ONU and method for servicing Ethernet-based digital broadcasting, which aim at flourishing of digital broadcasting in a simple manner and at low cost when transmitting digital broadcasting data via an Ethernet passive optical network (EPON).

2. Description of the Related Art

FIG. 1 is a block diagram of a conventional EPON that uses an ONU. The EPON includes an optical line terminal (OLT) 10, a splitter 11, an ONU 12, and an optical network terminal (ONT) 13. The OLT 10 is connected to a Metro or a backbone network and acts as a hub to an access network. The link is connected to the splitter 11, which splits a signal from the OLT 10 into N signals. The split signals are transmitted to the ONU 12 or the ONT 13. That is, a signal that downstreams from the OLT 10 is transmitted to the ONU 12 and the ONT 13. The ONU 12 is connected to a plurality of subscribers, each including a home gateway (HG) 14, which is connected to user terminals such as a setup box (STB), a PC, and the like.

The ONU 12 examines a logical link identification (LLID) field of an input Ethernet frame. The ONU 12 receives the Ethernet frame if the LLID field corresponds to the ONU 12, and the ONU 12 does not receive the Ethernet frame if the LLID field does not correspond to the ONU 12. The operation of an ONU of the present invention will be described in detail later.

Conventionally, an IP multicasting method is used to digitally broadcast data through an EPON. Briefly, an Ethernet frame that encapsulates an MPEG stream is input to the OLT 10, and the OLT 10 and the ONU. 12 filter a multicast frame using Internet group management protocol (IGMP) snooping and transmit a corresponding broadcasting frame to a subscriber.

However, the IP multicasting method requires a complicated structure in that the OLT 10 and the ONU 12 need examine and control functions for layer 2 and layer 3.

FIG. 2 is a block diagram of a conventional cable broadcasting network.

A system operator (SO) distribution center 21 is connected to a subscriber 22 through hybrid fiber coaxial (HFC) network in which an optical cable and a coaxial cable are mixed. Although the main purpose of the cable broadcasting network is to provide viewing of the cable TV, multiple services such as Internet service, video-on-demand (VOD) service, telephone service are being developed to effectively utilize the bandwidth of the network.

However, there are too many subscribers to the conventional cable broadcasting network for the bandwidth of the Internet service, and the cable broadcasting network is improper for digital cable broadcasting since it is established for analog broadcasting.

FIG. 3 is a block diagram of a conventional EPON that simultaneously services communications and broadcasting using an overlay structure. Nonbroadcasting data (hereinafter, referred to as common data) and broadcasting data, which are provided by the OLT 10, are multiplexed into a multi-wavelength single optical signal by a transmission coupler 303. The multiplexed optical signal is transmitted via a single link to a receiving coupler 304, de-multiplexed by the receiving coupler 304, and transmitted to ONU/ONT 12. Research for the overlay structure is now being performed and the wavelengths for EPON downstream, EPON upstream, and broadcasting data downstream are 1490 nm, 1310 nm and 1550 nm, respectively.

The method of servicing communications and broadcasting using the overlay structure as shown in FIG. 3 can utilize the limitless bandwidth of an optical cable for transmission of each of common data and broadcasting data with no restriction on the number of channels. However, as broadcasting requested by a subscriber, such as VOD, is still processed as common data, an EPON downstream wavelength (1490 nm) 307 is used for the broadcasting. Also, since a plurality of wavelengths are divided and used for respective data and expensive optical components are required for optical power amplification, the foregoing method is costly. In other words, since the method of using the overlay structure is technically possible but not economical, it hinders the flourishing of digital cable broadcasting.

### SUMMARY OF THE INVENTION

The present invention provides an optical network unit (ONU) and method for servicing Ethernet-based digital broadcasting, the ONU and method which aim at flourishing of digital broadcasting by a simple method and at low cost when providing digital broadcasting data through an EPON.

According to an aspect of the present invention, there is provided an optical network unit (ONU) for servicing Ethernet-based digital broadcasting via an Ethernet passive optical network (EPON), comprising a received frame classifier, which receives an Ethernet frame from an optical line terminal (OLT) and classifies the Ethernet frame into a digital broadcasting frame or a nonbroadcasting frame; a broadcasting frame classifier, which sorts the digital broadcasting frame according to channels; and a broadcasting frame processing unit, which examines a channel requested by a subscriber and transmits a broadcasting frame corresponding to the channel to the subscriber.

According to another aspect of the present invention, there is provided a method of servicing Ethernet-based digital broadcasting via an EPON, comprising classifying an Ethernet frame received from an OLT into a digital broadcasting frame or a nonbroadcasting frame; sorting the digital broadcasting frame according to channels; and examining a channel requested by a subscriber and transmitting a broadcasting frame corresponding to the channel to the subscriber.

### BRIEF DESCRIPTION OF THE DRAWINGS

The above object and advantages of the present invention will become more apparent by describing in detail exemplary embodiments thereof with reference to the attached drawings in which:

FIG. 1 is a block diagram of a conventional EPON that uses an ONU;

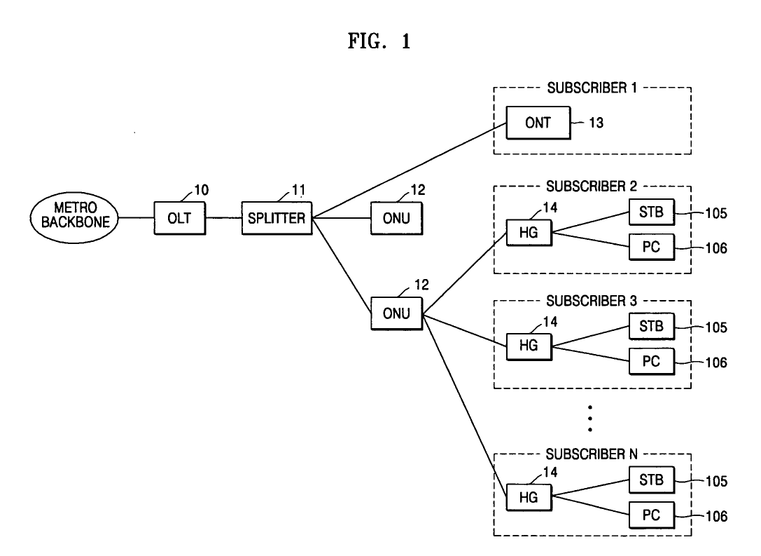

FIG. 2 is a block diagram of a conventional cable broadcasting network;

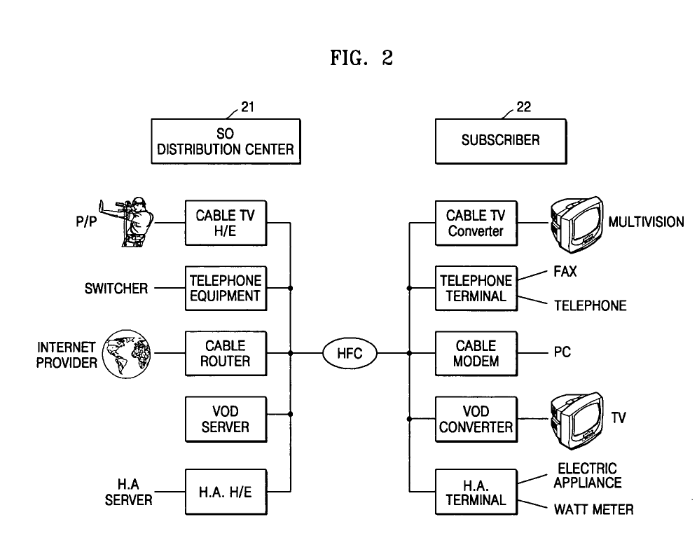

FIG. 3 is a block diagram of a conventional EPON that simultaneously services communications and broadcasting using an overlay structure;

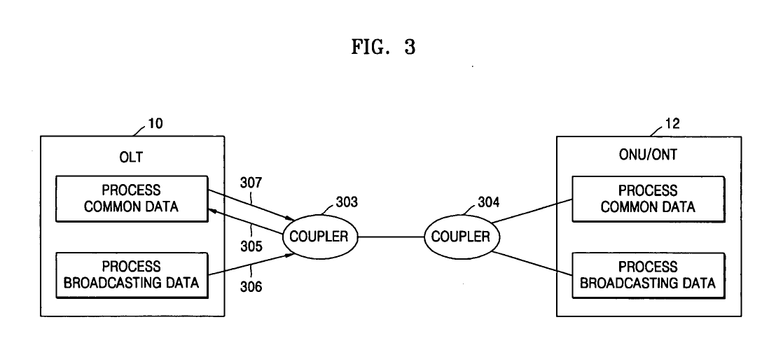

FIG. 4 illustrates a data structure of an Ethernet frame stream between an OLT 10 and an ONU 12 when data downstreams to a subscriber;

FIG. 5A is a block diagram of an ONU according to the present invention;

FIGS. 5B and 5C are flowcharts illustrating a method of servicing Ethernet-based digital broadcasting according to the present invention;

FIG. 5D illustrates a format of storing the broadcasting frame in a broadcasting frame storage unit shown in FIG. 5A;

FIG. 6 is a structural diagram of a multicast database shown in FIG. 5A;

FIG. 7 is a structural diagram of a request channel database shown in FIG. 5A; and

FIG. 8 illustrates a data structure of frames between the ONU and the HG.

### DETAILED DESCRIPTION OF THE INVENTION

The present invention will now be described more fully with reference to the accompanying drawings, in which exemplary embodiments of the invention are shown.

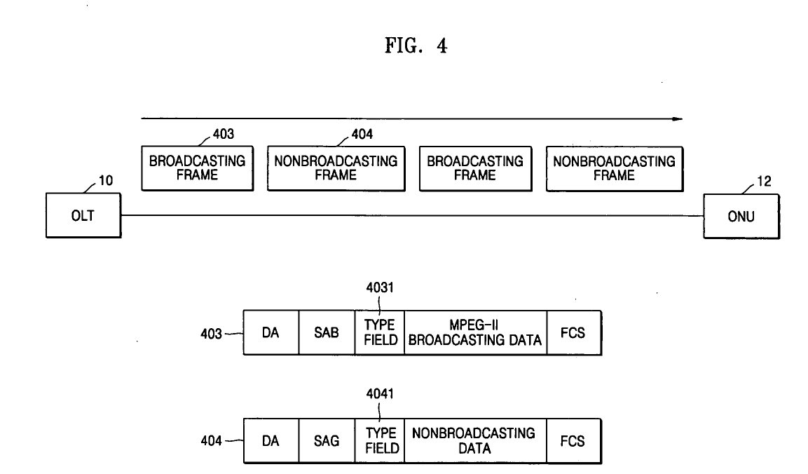

FIG. 4 illustrates a data structure of an Ethernet frame stream between an OLT 10 and an ONU 12 when data downstreams to a subscriber. Unlike in a conventional method in which a wavelength for common data and a wavelength for broadcasting frame 403 are allocated to a link using wavelength division multiplexing (WDM), in the present invention, broadcasting frames and nonbroadcasting frames are multiplexed and transmitted in an Ethernet frame format with a single optical wavelength to the ONU 12.

To discern the types of the frames, source addresses SAB and SAG and type fields 4031 and 4041 are used. In the case of a broadcasting frame 403, the source address SAB is allocated to a broadcasting multicast address. Broadcasting frames can be represented using the type fields 4031 and 4041, which are used to discern the types of frames, since the type fields 4031 and 4041 have values other than preset values. For example, if a frame is a nonbroadcasting frame, the type field 4041 is designated 0800 as a hexadecimal value, and if the frame is a broadcasting frame, the type field 4031 is designated CAxx as a hexadecimal value. The first two digits of hexadecimal value CAxx indicate a broadcasting frame and the second two digits of hexadecimal value CAxx indicate a unique broadcasting channel. That is, the OLT 10 distinguishes the broadcasting frame from the nonbroadcasting frame and transmits the Ethernet frame to the ONU 12.

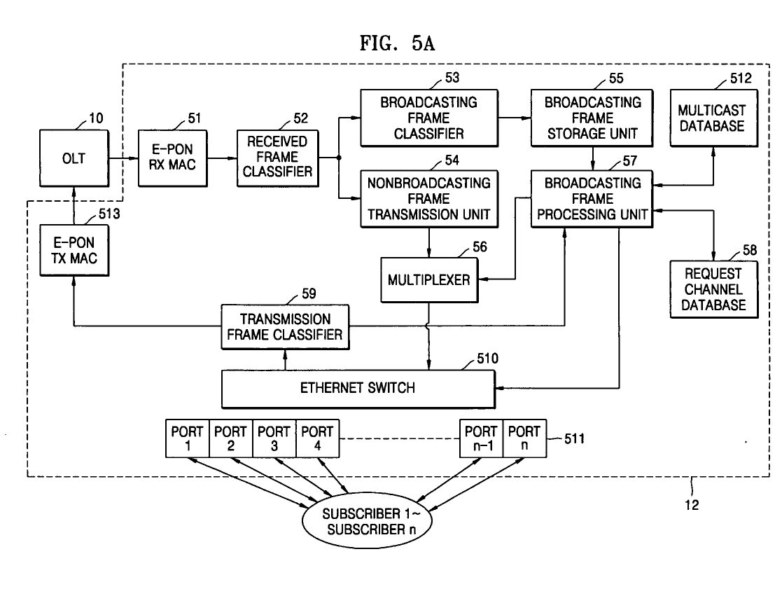

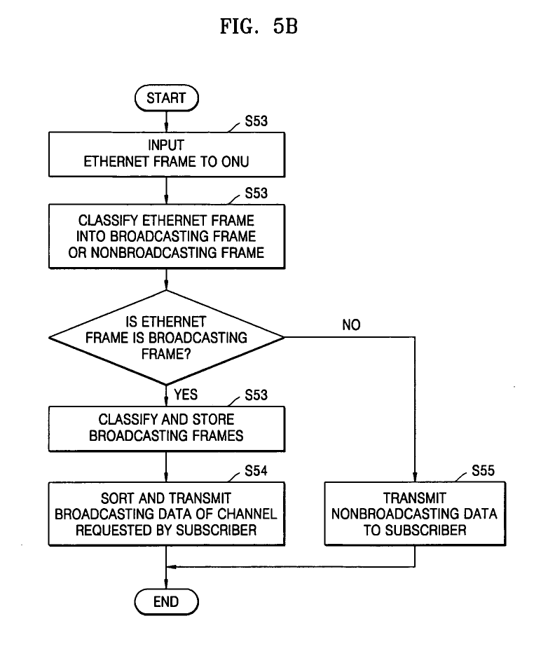

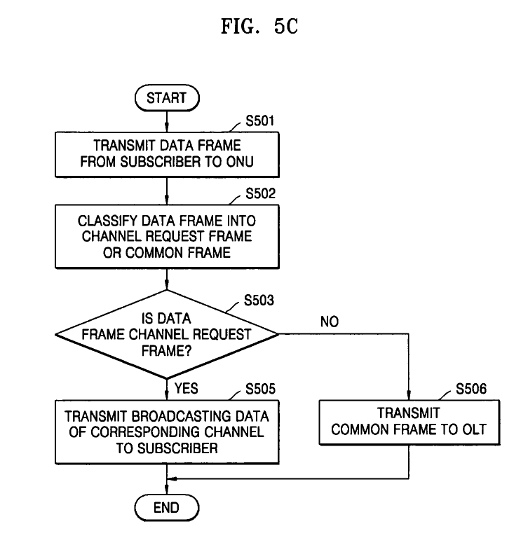

FIG. 5A is a block diagram of an ONU according to the present invention, and FIGS. 5B and 5C are flowcharts illustrating a method of servicing Ethernet-based digital broadcasting. FIGS. 5B and 5C relate to downstream data and upstream data, respectively.

Referring to FIGS. 5A and 5B, an Ethernet frame is input from an OLT 10 of an EPON to an ONU in step 51. After an EPON header is removed from the Ethernet frame by an EPON RX MAX 51, the Ethernet frame is input to a received frame classifier 52. The received frame classifier 52 examines the type field of the Ethernet frame and classifies the Ethernet frame into a nonbroadcasting frame or a broadcasting frame in step 52.

If the Ethernet frame is a broadcasting frame, it is input to a broadcasting frame classifier 53. In step 53, the broadcasting frame classifier 53 examines the type field of the input broadcasting frame, sorts broadcasting frames according to channels, and stores the sorted broadcasting frame in a corresponding channel memory of a broadcasting frame storage unit 55.

FIG. 5D illustrates a format of storing the broadcasting frame in the broadcasting frame storage unit 55 shown in FIG. 5A.

The broadcasting frame storage unit 55 receives the broadcasting frame from the broadcasting frame classifier 53, separates data for each of the channels, and stores the data according to the channels. In the present embodiment, the broadcasting frame is in the format of an MPEG-2 stream. The broadcasting frame storage unit 55 comprises a channel identification (ID) 514 and a memory 515 for storing data in corresponding channels. For example, the memory 515 may be an external memory, whose memory space is divided into memory regions that are each allocated to a channel. Thus, if a frame is input to the memory 515, the frame can be stored in a memory region that is allocated to the corresponding channel. Here, the size of the memory 515 varies according to the number of frames to be stored in each channel.

In step 54, a broadcasting frame processing unit 57 receives a channel request frame from a subscriber, examines the channel request frame, and stores information regarding the channel request frame in a request channel database 58. To transmit the broadcasting data of the channel requested by the subscriber, the broadcasting frame processing unit 57 examines request channels stored in a request channel database 58, reads the broadcasting frame of the corresponding channel from the broadcasting frame storage unit 55, and transmits the broadcasting frame to a multiplexer 56.

If one channel is requested by several ports at the same time, an Ethernet switch 510 should be controlled such that the broadcasting frame of the channel is transmitted to all of the ports at the same time, i.e., such that multicasting is enabled. For this, the broadcasting frame processing unit 57 examines the present request channel stored in the request channel database 58, stores multicast information on each channel (corresponding port information and allocated address of each port) in a multicast data base 512, and informs the Ethernet switch 510 of the multicast information of each channel. Based on the multicast information, the Ethernet switch 510 groups the ports that request a channel at the same time into a multicast group and controls an input frame such that the input frame is transmitted to the ports at the same time.

In step 55, a nonbroadcasting frame transmission unit 54 examines source addresses or certain fields (type fields) of an input nonbroadcasting frame, discards the present frame if the frame does not correspond to an ONU receiving the present frame, and transmits the present frame and nonbroadcasting data to a subscriber if the frame corresponds the ONU receiving the present frame. As described above, the nonbroadcasting data refers to data other than broadcasting data, such as Internet data.

In steps 54 and 55, a packet input from the nonbroadcasting frame transmission unit 54 and the broadcasting frame processing unit 57 is transmitted to the Ethernet switch 57 via the multiplexer 56 and transmitted to each subscriber via a corresponding port 511. Data transmitted via the multiplexer 56 is determined according to a request service signal of a subscriber. A home gateway (HG) 14 is connected to a PC 106 and a set top box (STB) 105 on the subscriber's premises. The HG 14 examines an input frame, transmits the input frame to the PC 106 if the input frame is a nonbroadcasting frame, and transmits the input frame to the STB 105 if the input frame is a broadcasting frame.

Referring to FIGS. 5A and 5C, common data and broadcasting channel request data (upstream), which are generated by a subscriber, are transmitted in an Ethernet frame format via the HG 14 to the ONU 12 in step 501.

In step 502, the Ethernet frame transmitted to the ONU 12 is transmitted to a transmission frame classifier 59 via the Ethernet switch 510. Then, the transmission frame classifier 59 examines the type field of the input Ethernet frame to verify whether the Ethernet frame is a broadcasting channel request frame or a non-channel request frame (hereinafter, a common frame) in step 503. If the Ethernet frame is a broadcasting channel request frame, the transmission frame classifier 59 sends it to the broadcasting frame processing unit 57 in step 505, and if the Ethernet frame is a common frame, the transmission frame classifier sends it to the OLT 10 via the EPON TX MAC 513.

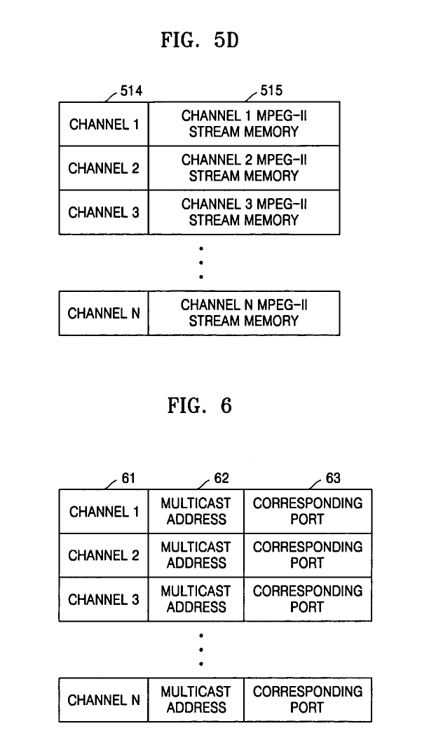

FIG. 6 is a structural diagram of a multicast database 512 shown in FIG. 5A. The multicast database 512 is generated and managed by the broadcasting frame processing unit 57. The multicast database 512 stores information regarding ports that request channels and information regarding multicast addresses allocated to the requested channels. The multicast database 512 includes channel IDs 61, multicast addresses 62, and corresponding ports 63.

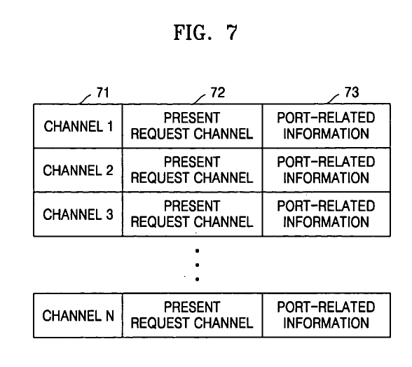

FIG. 7 is a structural diagram of the request channel database 58 shown in FIG. 5A.

The request channel database 58 stores channel request information provided by the subscribers. For this purpose, the request channel database 58 stores port IDs 71, present request channels 72, and port-related information 73. Since one port may request several channels at once, the present request channels may include a plurality of channels. The port-related information may include information regarding recently requested channels and channels requested for a predetermined amount of time, and preferred channels of each port. For example, the memory may be an external memory, whose memory space is divided into memory regions that are respectively allocated to respective ports.

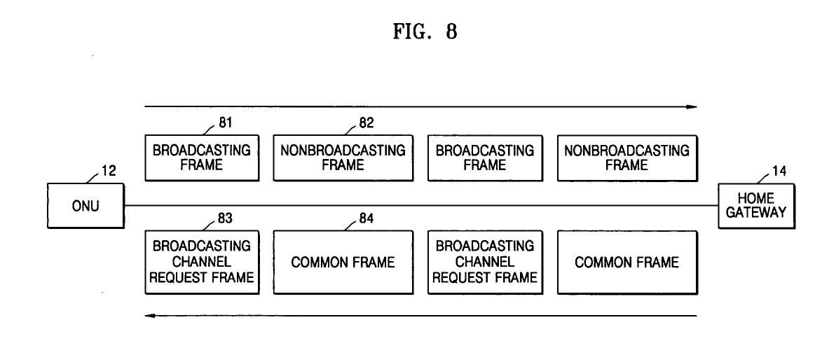

FIG. 8 illustrates a data structure of frames between the ONU and the HG.

Downstream data, which is transmitted from the ONU 12 via a port to the corresponding HG 14, includes a nonbroadcasting frame 82 and a broadcasting frame 81. Upstream data, which is transmitted from the HG 14 to the ONU 12, includes a common frame 84 and a broadcasting channel request frame 83. The broadcasting channel request frame 83 is in accordance with the format of an Ethernet frame and a unique value is allocated to a type field.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present invention, a channel request frame from a subscriber uses an Ethernet frame. Thus, to receive digital broadcasting via an EPON, all broadcasting controls are performed by functions relevant to layer 2 without functions relevant to layer 3, such as IGMP snooping. Thus, a control structure of an ONU can be simplified. Also, broadcasting data can be transmitted together with common data without allocating it to an additional link or wavelength. Consequently, communications of broadcasting data and common data between an OLT and an ONU and between an ONU and an HG are enabled by controls relevant to layer 2 using Ethernet frames. Therefore, the method of the present invention is advantageous with respect to hardware and software since it requires no additional functions relevant to upper layer, i.e., layer 3, such as IGMP snooping, which is required in the conventional method.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

1. An optical network unit (ONU) for servicing Ethernet-based digital broadcasting via an Ethernet passive optical network (EPON), the ONU comprising:
a received frame classifier, which receives an Ethernet frame from an optical line terminal (OLT) and classifies the Ethernet frame into a digital broadcasting frame or a nonbroadcasting frame;
a broadcasting frame classifier, which sorts the digital broadcasting frame according to channels; and
a broadcasting frame processing unit, which examines a channel requested by a subscriber and transmits a broadcasting frame corresponding to the requested channel to the subscriber.

2. The ONU of claim 1, further comprising a transmission frame classifier, which receives a transmission Ethernet frame from the subscriber and classifies the transmission Ethernet frame into a broadcasting request frame or a common frame.

3. The ONU of claim 1, wherein the received frame classifier classifies the Ethernet frame using source addresses and type fields of the Ethernet frame.

4. A method of servicing Ethernet-based digital broadcasting via an EPON, the method comprising:
classifying an Ethernet frame received from an OLT into a digital broadcasting frame or a nonbroadcasting frame;
sorting the digital broadcasting frame according to channels; and
examining a channel requested by a subscriber and transmitting a broadcasting frame corresponding to the requested channel to the subscriber.

5. The method of claim 4, further comprising classifying a transmission Ethernet frame received from the subscriber into a broadcasting request frame or a common frame.

6. The method of claim 4, wherein the classifying of the Ethernet frame comprises classifying the Ethernet frame using source addresses and type fields of the Ethernet frame.

7. A computer readable medium having embodied thereon a computer program for the method according to claim 4.
